(19) United States
(12) Patent Application Publication
(10) Pub. No.: US 2002/0166424 A1
(43) Pub. Date: Nov. 14, 2002

(54) METHOD FOR PRODUCING PHOTOGRAPHIC FILM

(76) Inventor: NOBUMITSU TAKAHASHI, MINAMIASHIGARA-SHI (JP)

Correspondence Address: SUGHRUE MION ZINN MCPEAK & SEAS PLLC, 2100 PENNSYLVANIA AVENUE NW, WASHINGTON, DC, 200373213

(21) Appl. No.: 09/473,995

(22) Filed: Dec. 29, 1999

(30) Foreign Application Priority Data
Mar. 11, 1999 (JP) 11-64492

(51) Int. Cl. B26D 1/14

(52) U.S. Cl. 83/13; 83/493; 83/948

(57) ABSTRACT

A wide-width photographic film is adjusted to have a predetermined supply speed V1 by a sheet feed roller operated by a motor, and it is supplied between upper blades and lower blades. The wide-width photographic film is pressed by an upper blade-pressing mechanism, and it is cut between the upper blades operated by an AC servo motor and rotated at a predetermined circumferential speed V2, and the lower blades operated by the motor and rotated at a predetermined circumferential speed V3. In this process, V1 ×0.1<V2<V1×0.5 is satisfied.

### BACKGROUND OF THE INVENTION

1. Field of the Invention

The present invention relates to a method for producing photographic film, in which a wide-width photographic film is subjected to shear cut to produce narrow-width photographic films by using pairs of upper and lower round blades.

2. Description of the Related Art

At present, a variety of photographic films are used. For example, those widely utilized for the general photographing operation include a roll of film provided with a spool which is rotatable at the inside of a main cartridge body composed of a light-shielding case component. One end of a band-shaped photographic film is fixed to the spool, and the photographic film is wound therearound.

Such a photographic film cartridge has a compact size and a light weight as compared with conventional one. Further, the photographic film is repeatedly wound into and drawn from the cartridge. Therefore, such a photographic film is required to have a thin thickness, a high strength, and excellent durability as compared with conventional films.

TAC (triacetate cellulose) and PET (polyethylene terephthalate) have been hitherto used as a base material for the photographic film. However, at present, in place of such base materials, PEN (polyethylene naphthalate), which is more excellent in strength and other properties, is adopted as a base material for the photographic film. A film sheet is formed by applying a photosensitive emulsion to a sheet-shaped film base composed of PEN. The photographic film as described above has a shape of large photographic film sheet at the early stage of production. The photographic film for the photographing operation is produced by cutting the large photographic film sheet into pieces each having a predetermined width.

A method for cutting the photographic film has been hitherto used, in which pairs of upper and lower round blades are meshed with each other to cut the photographic film, i.e., a so-called shear cut procedure has been hitherto used. In this method, when the conventional TAC-based photographic film is cut, the circumferential speed of each of the upper and lower blades is made approximately the same as the supply speed of the photographic film. The cutting edge angle of the upper blade is generally designed to be about 60 degrees, in view of the service life of the edged tool. FIG. 8 shows cutting planes 102a, 102b obtained when a TAC-based photographic film 100 is cut by using the conventional method.

However, when a cutter apparatus, which has the upper blade and the lower blade as described above, is used to cut a photographic film composed of a film base of PEN, the smoothness of an obtained cutting plane is extremely deteriorated as compared with a cutting plane of a photographic film composed of a film base of TAC or PET, which is not preferred (see FIG. 5).

In view of this fact, the present applicant has previously suggested a shear cut method (see Japanese Laid-Open Patent Publication No. 9-193085), in which the circumferential speeds of upper and lower blades and the supply speed of the photographic film are adjusted. Specifically, the circumferential speed of the upper blade is adjusted to be 50% to 95% of the circumferential speed of the lower blade, and the supply speed of the photographic film is adjusted to be 95% to 100% of the circumferential speed of the lower blade. FIG. 9 shows a state of cutting planes 112a, 112b obtained when a PEN-based photographic film 110 is cut by using the suggested illustrative method. According to this method, an inconvenience is avoided, which would be otherwise caused such that chips, film hairs or the like are formed on the cutting plane, and the quality of the photographic film is deteriorated. However, a cutting plane, which is obtained exactly when TAC or PET is used as a film base, is not obtained.

Further, the operation, which is performed within the circumferential speed range described and used in the suggested illustrative method, fails to completely remove film hairs, although the appearance of film hairs is improved. Therefore, no film hair is disengaged or separated from the film. However, when it is intended to regulate the film by using a guide plate in the widthwise direction with respect to the transport direction in the steps following the cutting operation, the film hairs slide on the guide plate to increase the frictional resistance, resulting in an inconvenience that any jamming is caused in some cases.

A technique has been also disclosed as the related art in relation to a method for shearing a magnetic tape (see Japanese Laid-Open Patent Publication No. 62-202385). In this technique, a fixed linear blade or a round blade is used, in which the shear angle (angle of intersection between the magnetic tape and the cutting edge) is an acute angle of not less than 5 degrees. Further, the circumferential speed of the round blade is not more than 1/10 (not more than V×0.1) of the feed speed (V) of the magnetic tape.

According to this method, for example, it is possible to solve the problem which would be otherwise caused such that when a magnetic tape comprising a magnetic layer of about 5 μm formed on a plastic film of about 15 μm is cut, for example, then any shearing trace remains in the thickness direction on end surfaces of both side edges of the magnetic tape, and the magnetic layer is disengaged from the edges. However, even when this technique is used to cut, for example, a photographic film of about 50 μm which is thicker than the magnetic tape, then the friction is increased between the edge and the upper blade, and chips are produced, which is not necessarily preferred.

### SUMMARY OF THE INVENTION

An object of the present invention is to provide a method for producing photographic film, which makes it possible to avoid any appearance of chips, film hairs or the like on a cutting plane so that any inconvenience is dissolved more reliably, which would otherwise deteriorate the quality of the photographic film.

The present invention lies in a method for producing photographic film, in which a wide-width photographic film composed of a film base of PEN (polyethylene naphthalate) is subjected to shear cut to produce narrow-width photographic films by using upper and lower round blades, wherein a circumferential speed (V2) of the upper blade satisfies the following relationship with respect to a supply speed (V1) of the wide-width photographic film:

V1×0.1<V2<V1×0.5.

Accordingly, it is possible to avoid any appearance of chips, film hairs or the like on a cutting plane. Further, the emulsion layer is prevented from peeling off and disengagement, and it is also possible to avoid any occurrence of jamming during the transport. Thus, it is possible to obtain the photographic film having a high quality.

In this method, the upper blade may have a cutting edge angle of not less than 50 degrees and less than 90 degrees in cross section. By doing so, it is possible to preferably avoid any appearance of chips, film hairs or the like on the cutting plane of the photographic film.

Especially, in the present invention, when each of the upper blade and the lower blade is allowed to have a thin blade shape, it is possible to prolong the service life of the edged tool. In this context, the thin blade shape refers to a shape in which the cutting edge angle of the upper blade and the lower blade is not less than 50 degrees and less than 90 degrees. Specifically, when both of the upper blade and the lower blade are allowed to have the thin blade shape, then the area to contact with the photographic film is decreased, and it is possible for both of the upper blade and the lower blade to contact with the photographic film while ensuring the difference in circumferential speed. Accordingly, the difference in relative speed disappears between the edged tools. Therefore, the durability of the edged tool is improved. The effect as described above can be obtained especially remarkably when the following relationship is satisfied provided that a circumferential speed of the lower blade is V3 with respect to the supply speed of the photographic film:

V1×0.1<V2=V3<V1×0.5.

Further, in the method for producing the photographic film according to the present invention, it is more preferable that the photographic film has a thickness of not less than 50 μm and less than 200 μm, because of the following reason. That is, if the thickness is less than 50 μm, then the photographic film is greatly deformed, and it is impossible to obtain a constant width size. On the other hand, if the thickness is not less than 200 μm, then the cutting resistance is increased, the edged tool is possibly broken, or the photographic film is possibly damaged.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 shows a schematic perspective view illustrating a shear cutter to be used for a production method according to an embodiment of the present invention;

FIG. 2 shows a schematic sectional view for illustrating a cutting state of a photographic film and upper and lower blades of the shear cutter to be used for the production method according to the embodiment of the present invention;

FIG. 3 shows an example of cutting planes of a PEN-based photographic film cut by the shear cutter to be used for the production method according to the embodiment of the present invention;

FIG. 4 shows an illustrative longitudinal sectional view depicting the width (t) of a crack formed in the PEN-based photographic film cut in accordance with the conventional method;

FIG. 5 shows an example of cutting planes of the PEN-based photographic film cut in accordance with the conventional method;

FIG. 6 shows a schematic perspective view illustrating a shear cutter to be used for a production method according to another embodiment;

FIG. 7 shows a schematic sectional view for illustrating a cutting state of a photographic film and upper and lower blades of the shear cutter to be used for the production method according to the another embodiment;

FIG. 8 shows cutting planes obtained when a TAC-based photographic film is cut in accordance with the conventional method; and

FIG. 9 shows cutting planes obtained when a PEN-based photographic film is cut in accordance with the suggested illustrative method.

### DESCRIPTION OF THE PREFERRED EMBODIMENTS

The method for producing the photographic film according to the present invention will be explained in detail below with reference to the accompanying drawings, as exemplified by preferred embodiments in relation to apparatuses for carrying out the method.

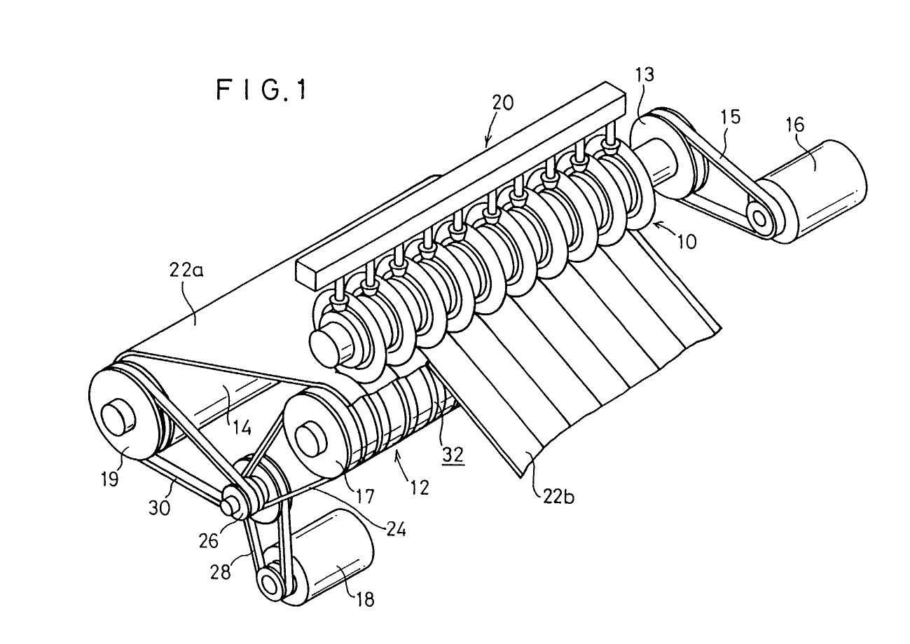

As shown in FIG. 1, a shear cutter, which is used for the method for producing the photographic film according to this embodiment, comprises upper blades 10, lower blades 12, and a sheet feed roller 14. The shear cutter further comprises an AC servo motor 16 for rotating the upper blades 10, and a motor 18 for rotating the lower blades 12 and the sheet feed roller 14.

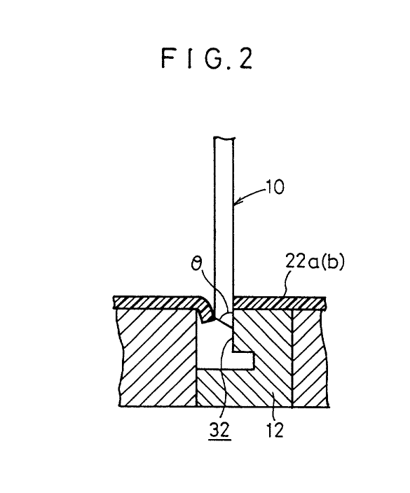

A pulley 13, which is secured to a rotary shaft of the upper blades 10, is connected via a belt 15 to the AC servo motor 16. For example, the inverter control is effected for the AC servo motor 16 so that the circumferential speed of the upper blades 10 is adjustable preferably within a range of 10% to 50% with respect to the supply speed of a photographic film 22a, the supply speed of the photographic film 22a being set in accordance with the number of revolutions of the sheet feed roller 14. In this embodiment, as shown in FIG. 2, the upper blade 10 is composed of a thin blade having a sharp forward end in cross section. An upper blade-pressing mechanism 20 is provided over the upper blades 10, for pressing the upper blades 10 against the lower blades 12.

A pulley 17, which is connected to a rotary shaft of the lower blades 12, is connected to the motor 18 via a belt 24, a pulley 26, and a belt 28. A pulley 19, which is connected to a rotary shaft of the sheet feed roller 14, is connected to the motor 18 via a belt 30, the pulley 26, and the belt 28. Therefore, it is easily understood that the mechanism is operated such that the sheet feed roller 14 and the lower blades 12 are rotated substantially in synchronization with each other. The circumferential speed of the lower blades 12 is adjustable with respect to the supply speed of the photographic film 22a by changing the diameter of the pulley 26.

The upper blades 10 and the lower blades 12 will now be explained. Each of the upper blades 10 is an acute angle blade having a cutting edge angle θ of about 70 degrees. On the other hand, each of the lower blades 12 is formed with a circumscribing groove 32 for meshing with the cutting edge of the upper blade 10 (see FIG. 2). In this embodiment, both of the upper blade 10 and the lower blade 12 have an outer diameter size of about 100 mm.

Explanation will be made below for a method for cutting the photographic film 22a by using the shear cutter constructed as described above. In this embodiment, the photographic film 22a to be used includes a film base 39 which is composed of PEN, and it has an overall thickness of not less than about 50 μm and less than 200 μm.

At first, the photographic film 22a, which is fed from an unillustrated original sheet roll, is adjusted to have a predetermined supply speed by the sheet feed roller 14 which is rotated and operated by the motor 18, and the photographic film 22a is supplied between the upper blades 10 and the lower blades 12. Assuming that the supply speed of the photographic film 22a is V1, and the circumferential speed of the upper blades 10 is V2, the speeds are adjusted to be regulated by the following expression:

V1×0.1<V2<V1×0.5.

The photographic film 22a is supplied at an angle perpendicular to the direction of the diameter of the upper blade 10 and the lower blade 12. However, the photographic film 22a may be supplied at an angle at which the photographic film 22a is somewhat wound around the lower blades 12 (see FIG. 1). The angle is not specifically limited. The upper blade-pressing mechanism 20 is pressed downwardly by an unillustrated driving mechanism against the photographic film 22a supplied as described above. The upper blades 10, which are operated and rotated by the AC servo motor 16, are meshed with the lower blades 12 which are operated and rotated by the motor 18. That is, the forward ends of the upper blades 10 substantially slide and contact with the walls which define the grooves 32 of the lower blades 12. Thus, the photographic film 22a is subjected to cutting (shear cut) by means of the shearing force between the both blades (see FIG. 2).

Each of photographic films 22b, which is cut into a predetermined width, is accommodated, for example, in an unillustrated photographic film cartridge.

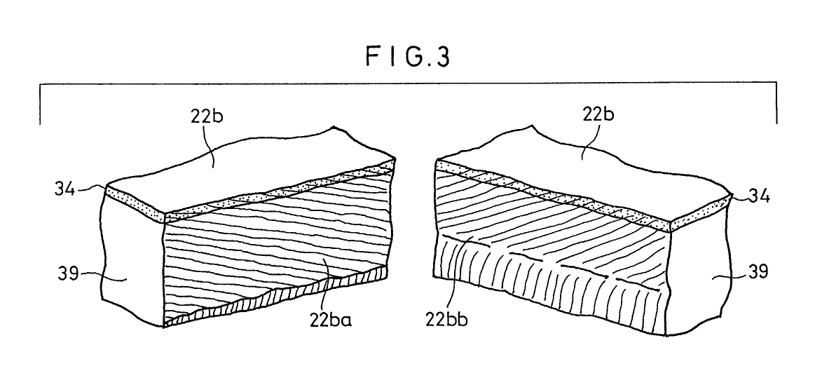

According to the method for producing the photographic film concerning the embodiment of the present invention, the cutting planes of the cut photographic film 22b having the film base 39 composed of PEN are obtained as shown in FIG. 3. That is, both of the first cutting plane 22ba and the second cutting plane 22bb are extremely smooth, on which no film hair appears. Further, the emulsion layer 34 is neither peeled off nor disengaged.

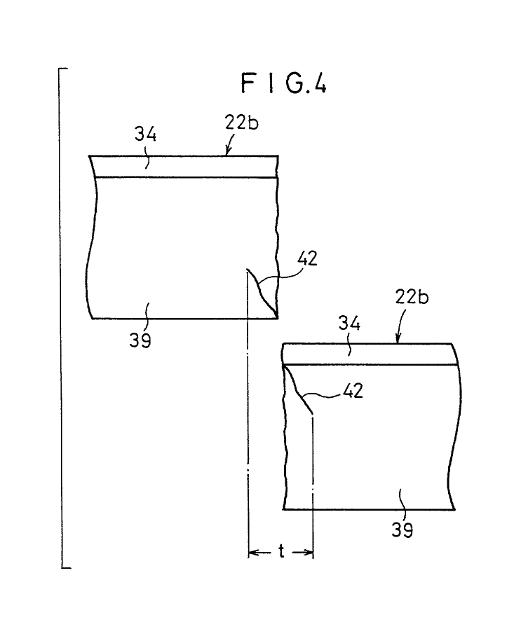

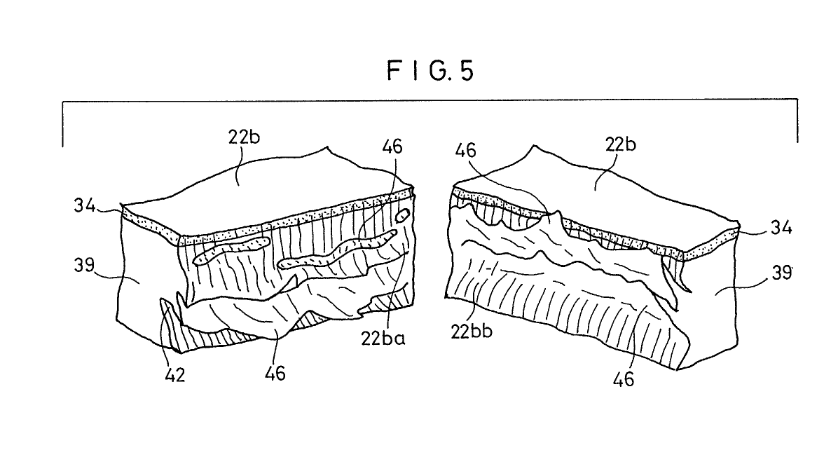

For the purpose of illustrative comparison, FIG. 4 shows cutting planes of the PEN-based photographic film 22b having been cut under the same condition as that used for TAC as described above, i.e., by using the conventional method based on the use of the shear cutter in which the circumferential speeds of the upper blades and the lower blades are the same as the supply speed of the photographic film. In this case, a crack 42, which is formed in the meshing direction of the upper blade 10 and the lower blade 12, appears to penetrate into the inside of the base. The width of the crack 42 arrives at a length (t). As a result, the cutting planes of the PEN-based photographic film 22b, which are obtained by the cutting based on the use of the conventional method, are those as shown in FIG. 5. That is, film hairs 46 conspicuously appear on both of the first cutting plane 22ba and the second cutting plane 22bb. Further, the emulsion layer 34 is conspicuously peeled off and disengaged. The quality of the photographic film is inferior.

The PEN-based photographic film 22a was cut by using the shear cutter under the following conditions. That is, the circumferential speed of the lower blades 12 was fixed to be 103% of the supply speed of the photographic film 22a. The relationship between the circumferential speed of the upper blades 10 and the supply speed of the photographic film 22a was changed within a range from a state in which the upper blades 10 were stopped to a state in which the circumferential speed (V2) of the upper blades 10 was the same as the supply speed (V1) of the photographic film 22a. Table 1 shows results obtained under these conditions, concerning the appearance of the film hair 46 on the cutting plane, the peeling off and disengagement of the emulsion layer 34, and the state of smoothness of the cutting plane.

In Table 1, double circles indicate extremely good states (see, for example, the state shown in FIG. 3), circles indicate good states (see, for example, the state shown in FIG. 9), triangles indicate inferior states, and crosses indicate extremely inferior states (see, for example, the state shown in FIG. 5).

TABLE 1

| Circumferential | | Peeling off/ | Smoothness |
|---|---|---|---|
| speed (V2) of | | disengagement of | of cutting |
| upper blade | Film hair | emulsion layer | plane |
| V1 × 1.0 | x | x | x |
| V1 × 0.9 | Δ | ∘ | Δ |
| V1 × 0.8 | ∘ | ∘ | ∘ |
| V1 × 0.7 | ∘ | ∘ | ∘ |
| V1 × 0.6 | ∘ | ∘ | ∘ |
| V1 × 0.5 | ⊚ | ⊚ | ⊚ |
| V1 × 0.4 | ⊚ | ⊚ | ⊚ |
| V1 × 0.3 | ⊚ | ⊚ | ⊚ |
| V1 × 0.2 | ⊚ | ⊚ | ⊚ |
| V1 × 0.1 | x | x | ⊚ |
| V1 × 0 | x | x | ⊚ |

(V1 = supply speed of photographic film)

Approximately the same tendency was exhibited concerning the appearance of the film hair 46, the peeling off and disengagement of the emulsion layer 34, and the state of smoothness of the cutting plane. Extremely good results were obtained in the embodiments of the present invention in which the circumferential speed (V2) of the upper blades 10 was up to 50% to 20% of the supply speed (V1) of the photographic film 22a. Inferior or extremely inferior results were obtained under the conditions except for the above.

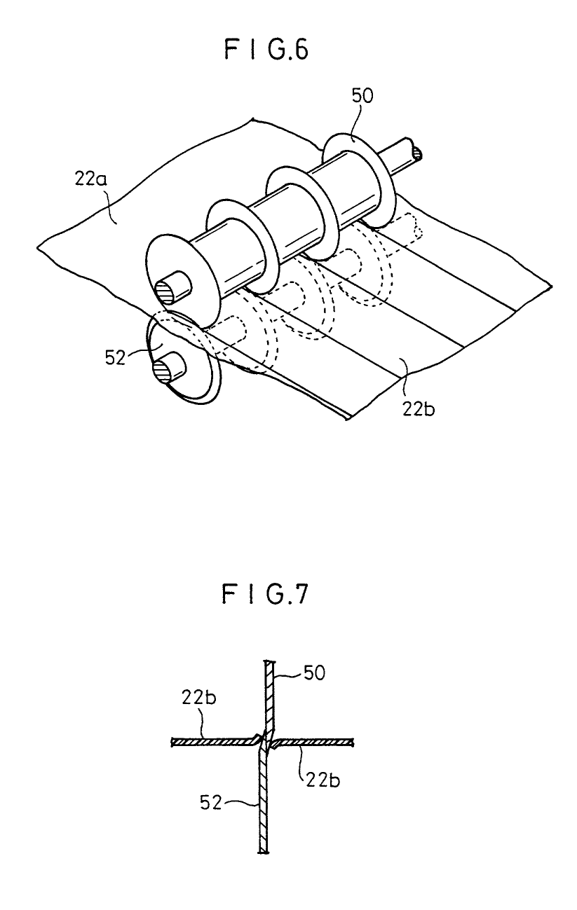

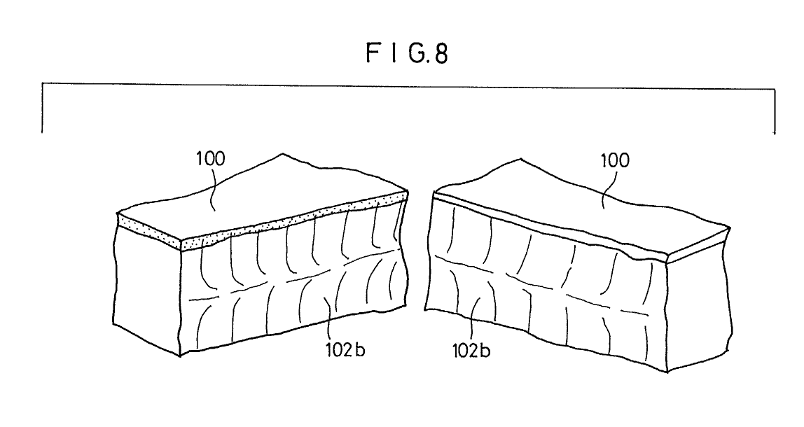

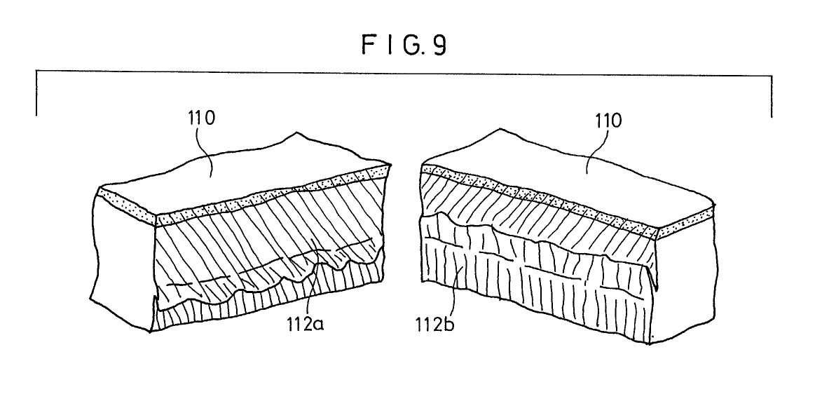

Next, explanation will be made for a method for producing photographic film according to another embodiment. As shown in FIGS. 6 and 7, a shear cutter, which is used in the production method according to the another embodiment, has upper blades 50 and lower blades 52 each of which is a thin blade with a forward end having the same angle in cross section. The photographic film 22a is supplied in a direction perpendicular to a direction of cutting edges of the upper blades 50 and the lower blades 52. When the method is carried out, the circumferential speed V3 of the lower blades 52 is adjusted to be a speed regulated by the following expression:

V1×0.1<V2=V3<V1×0.5.

According to this production method, the lower blades 52 are allowed to have the same circumferential speed as that of the upper blades 50, because the photographic film 22a is not wound around the lower blades 52. Therefore, it is possible to obtain the same effect of cutting as that obtained in the foregoing production method according to the embodiment of the present invention. Further, the service life of the edged tool can be prolonged, because there is no difference in speed between the upper blades 50 and the lower blades 52.

It is a matter of course that the method for producing the photographic film according to the present invention is not limited to the embodiments described above, which may be embodied in other various forms without deviating from the gist or essential characteristics of the present invention.

What is claimed is:

1. A method for producing photographic film, in which a wide-width photographic film composed of a film base of PEN (polyethylene naphthalate) is subjected to shear cut to produce narrow-width photographic films by using upper and lower round blades, wherein:
a circumferential speed V2 of said upper blade satisfies the following relationship with respect to a supply speed V1 of said wide-width photographic film:
V1×0.1<V2<V1×0.5.

2. The method according to claim 1, wherein said upper blade has a cutting edge angle of not less than 50 degrees and less than 90 degrees.

3. The method according to claim 1, wherein each of said upper blade and said lower blade has a thin blade shape, and the following relationship is satisfied by a circumferential speed V3 of said lower blade with respect to said supply speed of said wide-width photographic film:
V1×0.1<V2=V3<V1×0.5.

4. The method according to claim 1, wherein said photographic film has a thickness of not less than 50 μm and less than 200 μm.
